(19) United States
(12) Patent Application Publication
(10) Pub. No.: US 2023/0333961 A1
(43) Pub. Date: Oct. 19, 2023

(54) OPTIMIZING TRAINING DATA GENERATION FROM REAL-TIME PREDICTION SYSTEMS FOR INTELLIGENT MODEL TRAINING

(71) Applicant: PAYPAL, INC., San Jose, CA (US)

(72) Inventors: Sudhindra Murthy, Bengaluru (IN); Gopala Krishnan Yegya Narayanan, Chennai (IN); Vidya Sagar Durga, Bangalore (IN)

(21) Appl. No.: 17/721,993

(22) Filed: Apr. 15, 2022

(51) Int. Cl. G06F 11/34; G06N 20/20; G06Q 20/40

(52) U.S. Cl. CPC G06F 11/3476; G06N 20/20; G06Q 20/4016

(57) ABSTRACT

There are provided systems and methods for optimizing training data generation from real-time prediction systems for intelligent model training. A service provider, such as an electronic transaction processor for digital transactions, may utilize different computing environment and services that implement machine learning models and engines. The service provider may have a live adjudication environment where models use live data to adjudicate on requests by users, as well as an audit environment where models are trained and tested before deployment. Models may have directed graphs that designate the model dependencies on variables that are processed and values for those variables are used for an output. When variables are shared between models in the adjudication and audit environment, the values for the shared variables may be published to the audit computing environment for use without reloading and processing data, thereby reducing computational load from the audit environment.

### TECHNICAL FIELD

The present application generally relates to optimizing training data for machine learning (ML) models, and more particularly to optimizing training of ML models using data from a production computing environment for ML model training.

### BACKGROUND

Users may utilize computing devices to access online domains and platforms to perform various computing operations and view available data. Generally, these operations are provided by different service providers, which may provide services for account establishment and access, messaging and communications, electronic transaction processing, and other types of available services. During use of these computing services, the processing platforms and services, the service provider may utilize one or more decision services that implement and utilize ML engines and models for decision-making in real-time data processing, such as within a production computing environment. Service providers may utilize artificial intelligence (AI), such as ML systems and models for various services, including risk compute platforms and other risk analysis and/or fraud detection.

The ML platforms provide ML models that serve model scores to decisioning systems and perform real time predictions, such as for risk and fraud detection. The platforms may also perform logging of both adjudication and audit compute items, where adjudication compute items may result from decision-making and other ML model performance in production and/or real-time computing environments. The audit compute items may result from testing and auditing ML models in an offline or test computing environment. However, by utilizing multiple computing environments and devices or pools of devices, computational resources may be overused by the service providers systems, such as to repeat determination of compute items that are the same or similar between the adjudication and audit computing environments. As such, a balance needs to be found between real-time prediction systems and processing training data for developing ML models for real-time predictions in offline environments for audit ML model systems and ML model training.

### BRIEF DESCRIPTION OF THE DRAWINGS

FIG. 1 is a block diagram of a networked system suitable for implementing the processes described herein, according to an embodiment;

FIG. 2 is an exemplary system environment where a compute service and compute items from a real-time prediction pool are published and utilizing in an audit and training pool for machine learning models, according to an embodiment;

FIG. 3 is an exemplary diagram of a usage of compute items for variables from a real-time prediction pool utilizing in a training pool for machine learning models, according to an embodiment;

FIG. 4 is a flowchart of an exemplary process for optimizing training data generation from real-time prediction systems for intelligent model training, according to an embodiment; and

FIG. 5 is a block diagram of a computer system suitable for implementing one or more components in FIG. 1, according to an embodiment.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

Provided are methods utilized for optimizing data generation from real-time prediction systems for intelligent model training. Systems suitable for practicing methods of the present disclosure are also provided.

A service provider may provide different computing resources and services to users through different websites, resident applications (e.g., which may reside locally on a computing device), and/or other online platforms. When utilizing the services of a particular service provider, the service provider may provide decision services for implementing ML models and other intelligent decision-making operations with such services. For example, an online transaction processor may provide services associated with electronic transaction processing, including account services, user authentication and verification, digital payments, risk analysis and compliance, and the like. These services may further implement automated and intelligent decision-making operations and ML engines, including data processing engines that automate certain decision-making required by the systems. These decision services may be used for authentication, risk analysis, fraud detection, and the like to determine if, when, and how a particular service may be provided to users. For example, risk and/or fraud detection ML models may be utilized by a decision-making engine to determine whether electronic transaction processing of a requested digital transaction may proceed or be approved. The risk engine may therefore determine whether to proceed with processing the transaction or decline the transaction (as well as additional operations, such as request further authentication and/or information for better risk analysis).

However, when generating the training data for ML models in real-time prediction systems, the service provider may be required to maintain the availability and computing resources for the real-time production pools. For example, by using an audit computing environment and system, at any given time, a significant percentage (e.g., 30-40%) of the computational power for the service provider's computing system may be directed towards predictions performed by the non-adjudication (audit) compute items (e.g., in the test and/or audit computing environment). This computational power is further used to generate data out of these compute items for use in the offline environment for training purposes, which utilizes computing resources for analyzing training data, audit ML models, and/or ML model training. If properly validated and found efficient, trained ML models may then be incorporated into real-time predictions. The percentage of the computational power directed to the offline environment may therefore affect the latency and availability of the systems and corresponding computing resources.

A system may be provided that balances out the needs of both the inferencing and training requirements from the adjudication computing environments and the audit computing environments, respectively (e.g., from the adjudication ML models and systems and the audit ML models and systems). ML models and their dependencies may be classified into two parts, one which is time sensitive (e.g., point-in-time (PIT) decision-making and ML models) for adjudication/real-time decision-making, predictions, and compute items (e.g., models, components, and variables). The other part may be based on time slicing for compute items used for offline training data generation. By having two parts, computing resources, data loads, and the like, computational power may be used in offline computing environments, which may affect the live production computing environment.

In order to optimize the computational power, resources, and data loads between the production computing pool and ML model systems that perform inference for live computing environments and the offline computing environments for audit computing systems, a framework may be provided where compute items used for inferencing in the live computing environment may be published for and used in the audit pool and ML models. By logging different compute items in different computing environments, a feedback loop may be provided to ensure efficacy of models and facilitate training of the newer models in an offline or test computing environment (e.g., not the live production computing environment). The framework may include a centralized graph that has one or more ML models and their corresponding dependencies for model variables. These dependencies of the ML models may be included in the centralized graph (e.g., a directed acyclic graph (DAG) or the like) regardless of whether the ML model is being used in adjudication or audit computing environments and systems for the ML models.

For centralized graphs, ML models may have variables, which correspond to compute items where corresponding values are calculated and utilized for intelligent decision-making and other outputs. A variable may include a corresponding definition and/or description, which may define the function of the variable and the data loaded for ML model processing of the variable. The definition and/or description may be parsed in order to correlate different terms, identifiers, phrases, and the like. For example, a natural language processor and/or machine learning (ML) or other artificial intelligence (AI) system may be used to correlate different terms, phrases, functions, data objects, operations, and the like between different variables to determine linked and/or reused variables between different ML models. An ML system may be trained in order to parse and correlate different variables, for example, by providing training data correlations of variables and generating classifiers and other outputs that allow for linking of variables that perform the same or similar functions and/or operate on the same or similar data objects. In some embodiments, a mapping may be determined based on precomputed correlations in the service provider system. Further, an administrator or other vocabulary writer may also provide correlations and a mapping between variables.

The adjudication graph compute items and their dependencies may be processed in service level agreement (SLA) time, such as real-time or near real-time for decision-making and predictions using the ML model(s) (e.g., for a risk compute platform). Thereafter, values for the variables and other dependencies and a corresponding ML model output may be determined in SLA time and for the adjudication ML system. Thereafter, after the SLA time and decision-making and/or value determination for variables for ML models in the adjudication ML system, the centralized graph may have several nodes and corresponding variables that are processed and relevant to audit ML models and/or dependencies for variables. The DAG or other graph for an ML model may then be encoded via a messaging system to offload the processing of the changes or deltas between ML model graphs in a non-SLA constrained time for the audit ML environment and/or models. The messages and requests may then be dispatched via a forwarding agent to the training pool and audit computing environment for ML models. This may be done with the production system and databases that allows for loading and storing of values for variables used by the audit computing environment for ML model training (e.g., as training data). For example, values of variables that may be computed and then shared with the audit computing environment from the adjudication computing environment.

The framework and mechanisms may then ensure that data loads are not repeated and only the delta (e.g., changes in data loads, such as differences for variables and corresponding values that are not calculated in the adjudication ML system) is processed for the audit computing environment and ML model training. This allows for consolidated logging of the adjudication paths and the audit paths and downstream outputs so that variables and values are reused from previous data loading and processing, thereby preventing further computational resource usage for previous data loads and calculations. The system and framework may therefore provide the reusability of loaded data and reduces the system resource usage and computations for real-time decision, predictions, and ML model training. The time order of the variables may be preserved by capturing the computed variables, model scores, and the like, which may then be used for offline training of additional ML models.

The framework may provide for optimizing the computing resources and compute items by reusing calculated values for variables and other data loads from DAGs or other directed graphs for ML model dependencies. Thereafter, incremental computes may be done for the remaining variables and model computations required in the audit computing environment for ML model training. The variables may have corresponding data loads from container data structures (e.g., from the maintained PIT for the ML model execution in the adjudication ML system). This allows for extending the delegation of model computation with all the pre-processed variable dependencies to the training pool. This may further provide throughput improvement of the ML models and systems in performance and production computing environments as there is a separation of model serving to real-time predictions and model processing, caching, and logging for offline training. Thus, a risk async training pool may have a mechanism that enables inferencing and training by sharing values for calculated and processed variables in an efficient and improved manner.

In this regard, a computational and data processing platform may be provided that allows for the PIT decision-making and other ML outputs to be determined, which may then be utilized in an offline and/or audit computing environment. Pools of machines may therefore be optimized to utilize pre-computed data from the PIT outputs during ML model training using the platform. This may in turn optimize computing resource efficiency to prevent re-computation of previously determined values for variables that are shared between ML models. Thus, the platform allows for both PIT outputs and offline ML model training in a more efficient and coordinated manner. These operations by the platform may be provided in different computing environments for transaction processing, risk analysis, authentication and/or login, and other online computing systems where ML models may be deployed for intelligent decision-making. Thus, there may be provided improved ML model training, which, when a ML model increases model usage, improves system performance and reduces processing power consumption for service provider systems.

Thereafter, a service provider, such as an online transaction processor may provide services to users, including electronic transaction processing, such as online transaction processors (e.g., PayPal®) that allows merchants, users, and other entities to processes transactions, provide payments, and/or transfer funds between these users. When interacting with the service provider, the user may process a particular transaction and transactional data to provide a payment to another user or a third-party for items or services. Moreover, the user may view digital content, other digital accounts and/or digital wallet information, including a transaction history and other payment information associated with the user's payment instruments and/or digital wallet. The user may also interact with the service provider to establish an account and other information for the user. In further embodiments, other service providers may also provide computing services, including social networking, microblogging, media sharing, messaging, business and consumer platforms, etc. These computing services may be deployed across multiple different applications including different applications for different operating systems and/or device types. Furthermore, these services may utilize the aforementioned ML decision services and systems.

In various embodiments, in order to utilize the computing services of a service provider, an account with a service provider may be established by providing account details, such as a login, password (or other authentication credential, such as a biometric fingerprint, retinal scan, etc.), and other account creation details. The account creation details may include identification information to establish the account, such as personal information for a user, business or merchant information for an entity, or other types of identification information including a name, address, and/or other information. The user may also be required to provide financial information, including payment card (e.g., credit/debit card) information, bank account information, gift card information, benefits/incentives, and/or financial investments, which may be used to process transactions after identity confirmation, as well as purchase or subscribe to services of the service provider. The online payment provider may provide digital wallet services, which may offer financial services to send, store, and receive money, process financial instruments, and/or provide transaction histories, including tokenization of digital wallet data for transaction processing. The application or website of the service provider, such as PayPal® or other online payment provider, may provide payments and the other transaction processing services. Access and use of these accounts may be performed in conjunction with uses of the aforementioned ML services and systems.

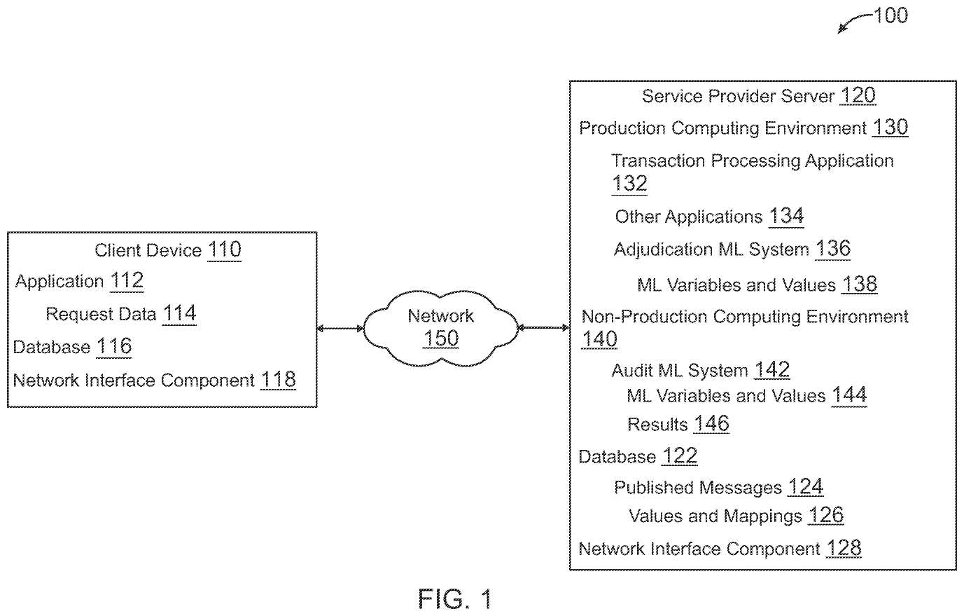

FIG. 1 is a block diagram of a networked system 100 suitable for implementing the processes described herein, according to an embodiment. As shown, system 100 may comprise or implement a plurality of devices, servers, and/or software components that operate to perform various methodologies in accordance with the described embodiments. Exemplary devices and servers may include device, stand-alone, and enterprise-class servers, operating an OS such as a MICROSOFT® OS, a UNIX® OS, a LINUX® OS, or another suitable device and/or server-based OS. It can be appreciated that the devices and/or servers illustrated in FIG. 1 may be deployed in other ways and that the operations performed, and/or the services provided by such devices and/or servers may be combined or separated for a given embodiment and may be performed by a greater number or fewer number of devices and/or servers. One or more devices and/or servers may be operated and/or maintained by the same or different entity.

System 100 includes a client device 110 and a service provider server 120 in communication over a network 150. Client device 110 may be utilized by a user to access a computing service or resource provided by service provider server 120, where service provider server 120 may provide various data, operations, and other functions to client device 110 via network 150 including those associated with adjudication and/or audit ML environments and systems for ML models. In this regard, client device 110 may be used to request real-time or other adjudication for AI or ML services, where the values and data loads for variables of the ML models may be published from the adjudication ML system to the audit ML system for use with training of ML models.

Client device 110 and service provider server 120 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 100, and/or accessible over network 150.

Client device 110 may be implemented as a communication device that may utilize appropriate hardware and software configured for wired and/or wireless communication with service provider server 120. For example, in one embodiment, client device 110 may be implemented as a personal computer (PC), a smart phone, laptop/tablet computer, wristwatch with appropriate computer hardware resources, eyeglasses with appropriate computer hardware (e.g., GOOGLE GLASS®), other type of wearable computing device, implantable communication devices, and/or other types of computing devices capable of transmitting and/or receiving data, such as an IPAD® from APPLE®. Although only one device is shown, a plurality of devices may function similarly and/or be connected to provide the functionalities described herein.

Client device 110 of FIG. 1 contains an application 112, a database 116, and a network interface component 118. Application 112 may correspond to executable processes, procedures, and/or applications with associated hardware. In other embodiments, client device 110 may include additional or different modules having specialized hardware and/or software as required.

Application 112 may correspond to one or more processes to execute software modules and associated components of client device 110 to provide features, services, and other operations for utilize ML or other AI systems and services of service provider server 120, where use of ML models by these systems and services may cause values for variables to be shared between live computing environments and audit computing environments for ML model training and testing. In this regard, application 112 may correspond to specialized hardware and/or software utilized by a user of client device 110 that may be used to access a website or UI provided by service provider server 120. Application 112 may utilize one or more UIs, such as graphical user interfaces presented using an output display device of client device 110, to enable the user associated with client device 110 to enter and/or view request data 114 for one or more processing requests, navigate between different data, UIs, and executable processes, and request processing operations for request data 114 based on services provided by service provider server 120. In some embodiments, the UIs may allow for requesting processing of request data 114 using one or more ML models in a live computing environment, which may correspond to a webpage, domain, service, and/or platform provided by service provider server 120.

Different services may be provided by service provider server 120 using application 112, including messaging, social networking, media posting or sharing, microblogging, data browsing and searching, online shopping, and other services available through online service providers. Application 112 may also be used to receive a receipt or other information based on transaction processing. In various embodiments, application 112 may correspond to a general browser application configured to retrieve, present, and communicate information over the Internet (e.g., utilize resources on the World Wide Web) or a private network. For example, application 112 may provide a web browser, which may send and receive information over network 150, including retrieving website information, presenting the website information to the user, and/or communicating information to the website, including payment information for the transaction. However, in other embodiments, application 112 may include a dedicated application of service provider server 120 or other entity (e.g., a merchant), which may be configured to assist in processing transactions electronically. Such operations and services may be facilitated and provider using one or more ML models utilized by service provider server 120. In this regard, request data 114 may be provided to service provider server 120 over network 150 for processing by the ML models and usage with different computing environments and ML model training.

Client device 110 may further include database 116 stored on a transitory and/or non-transitory memory of client device 110, which may store various applications and data and be utilized during execution of various modules of client device 110. Database 116 may include, for example, identifiers such as operating system registry entries, cookies associated with application 112 and/or other applications, identifiers associated with hardware of client device 110, or other appropriate identifiers, such as identifiers used for payment/user/device authentication or identification, which may be communicated as identifying the user/client device 110 to service provider server 120. Moreover, database 116 may include information for request data 114 were stored locally, or request data may be input via application 112.

Client device 110 includes at least one network interface component 118 adapted to communicate with service provider server 120. In various embodiments, network interface component 118 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices.

Service provider server 120 may be maintained, for example, by an online service provider, which may provide services that use data processing ML models with decision services and the like in live computing environments and systems to perform automated decision-making in an intelligent system. In this regard, service provider server 120 includes one or more processing applications which may be configured to interact with client device 110 to receive data for processing, such as request data 114, and provide computing services. In one example, service provider server 120 may be provided by PAYPAL®, Inc. of San Jose, CA, USA. However, in other embodiments, service provider server 120 may be maintained by or include another type of service provider.

Service provider server 120 of FIG. 1 includes a production computing environment 130, a non-production computing environment 140, a database 122, and a network interface component 128. Production computing environment 130 and transaction processing application 132 may correspond to executable processes, procedures, and/or applications with associated hardware. In other embodiments, service provider server 120 may include additional or different modules having specialized hardware and/or software as required.

Production computing environment 130 may correspond to one or more processes to execute modules and associated specialized hardware of service provider server 120 to provide a platform and framework used by one or more applications, services, and/or platforms of service provider server 120 during use of services and resources provided by service provider server 120. In this regard, production computing environment 130 may correspond to specialized hardware and/or software used by service provider server 120 that further intelligently utilizes ML models for adjudication and other decision-making with the computing services and operations available with production computing environment 130. In this regard, production computing environment 130 may include a transaction processing application 132 and other applications 134, which may utilize an adjudication ML system to provide intelligent decision-making, predictive services, and the like based on ML models and corresponding ML variables and values 138 for those models.

Transaction processing application 132 may correspond to one or more processes to execute modules and associated specialized hardware of service provider server 120 to process a transaction in production computing environment 130, which may utilize adjudication ML system 136. In this regard, transaction processing application 132 may correspond to specialized hardware and/or software used by a user associated with client device 110 to establish a payment account and/or digital wallet, which may be used to generate and provide user data for the user, as well as process transactions. In various embodiments, financial information may be stored to the account, such as account/card numbers and information. A digital token for the account/wallet may be used to send and process payments, for example, through an interface provided by service provider server 120. In some embodiments, the financial information may also be used to establish a payment account.

The payment account may be accessed and/or used through a browser application and/or dedicated payment application executed by client device 110 and engage in transaction processing through transaction processing application 132, such as application 112 that displays UIs from service provider server 120. Transaction processing application 132 may process the payment and may provide a transaction history to client device 110 for transaction authorization, approval, or denial. Such account services, account setup, authentication, electronic transaction processing, and other services of transaction processing application 132 may utilize adjudication ML system 136, such as for risk analysis, fraud detection, authentication, and the like. Thus, adjudication ML system 136 may implement ML models that determine ML variables and values based on data loads for one or more data processing requests, such as request data 114.

Other applications 134 may include additional applications to provide features in production computing environment 130. For example, other applications 134 may include security applications for implementing server and/or client-side security features, programmatic applications for interfacing with appropriate application programming interfaces (APIs) over network 150, or other types of applications. Other applications 134 may include email, texting, voice and IM applications that allow a user to send and receive emails, calls, texts, and other notifications through network 150. Other applications 134 may also include other location detection applications, which may be used to determine a location for client device 110. Other applications 134 may include interface applications and other display modules that may receive input from the user and/or output information to the user. For example, other applications 134 may contain software programs, executable by a processor, including a graphical user interface (GUI) configured to provide an interface to the user.

Adjudication ML system 136 may include one or more ML models that utilize data loads from data processing requests with variables from ML variables and values 138 to compute the corresponding values. One or more ML models may be trained to take, as input, at least training data and output a recommendation of a prediction, decision-making, or other intelligent recommendation or classification. ML models may include one or more layers, including an input layer, a hidden layer, and an output layer having one or more nodes, however, different layers may also be utilized. For example, as many hidden layers as necessary or appropriate may be utilized. Each node within a layer is connected to a node within an adjacent layer, where a set of input values may be used to generate one or more output scores or classifications. Within the input layer, each node may correspond to a distinct attribute or input data type that is used to train ML models.

Thereafter, the hidden layer may be trained with these attributes and corresponding weights using an ML algorithm, computation, and/or technique. For example, each of the nodes in the hidden layer generates a representation, which may include a mathematical ML computation (or algorithm) that produces a value based on the input values of the input nodes. The ML algorithm may assign different weights to each of the data values received from the input nodes. The hidden layer nodes may include different algorithms and/or different weights assigned to the input data and may therefore produce a different value based on the input values. The values generated by the hidden layer nodes may be used by the output layer node to produce one or more output values for the ML models that attempt to classify or predict recommendations and other intelligent ML model outputs.

Thus, when ML models are used to perform a predictive analysis and output, the input may provide a corresponding output based on the classifications, scores, and predictions trained for ML models. The output may correspond to a recommendation and/or action that service provider server 120 may take with regard to providing computing services and applications in production computing environment 130. By providing training data to train ML models, the nodes in the hidden layer may be trained (adjusted) such that an optimal output (e.g., a classification or a desired accuracy) is produced in the output layer based on the training data. By continuously providing different sets of training data and penalizing ML models when the output of ML models is incorrect, ML models (and specifically, the representations of the nodes in the hidden layer) may be trained (adjusted) to improve its performance in data classification. Adjusting ML models may include adjusting the weights associated with each node in the hidden layer. Thus, the training data may be used as input/output data sets that enable the ML models to make classifications based on input attributes.

In order to train the ML models, non-production computing environment 140 may be used, such as an audit computing system and/or environment where ML models may be train and tested. Audit ML system 142 may be used to provide the aforementioned training operations and services for one or more ML models that are later to be released, moved to, and/or utilized in production computing environment 130. In this regard, audit ML system 142 may provide training data generation and training/testing of one or more ML models. This may further be enhanced and made more efficient but utilizing data loads and corresponding values determined for variables of ML models used by adjudication ML system 136 where those variables (and thus corresponding values) are shared and further utilized by audit ML system 142 for training data purposes and ML model training.

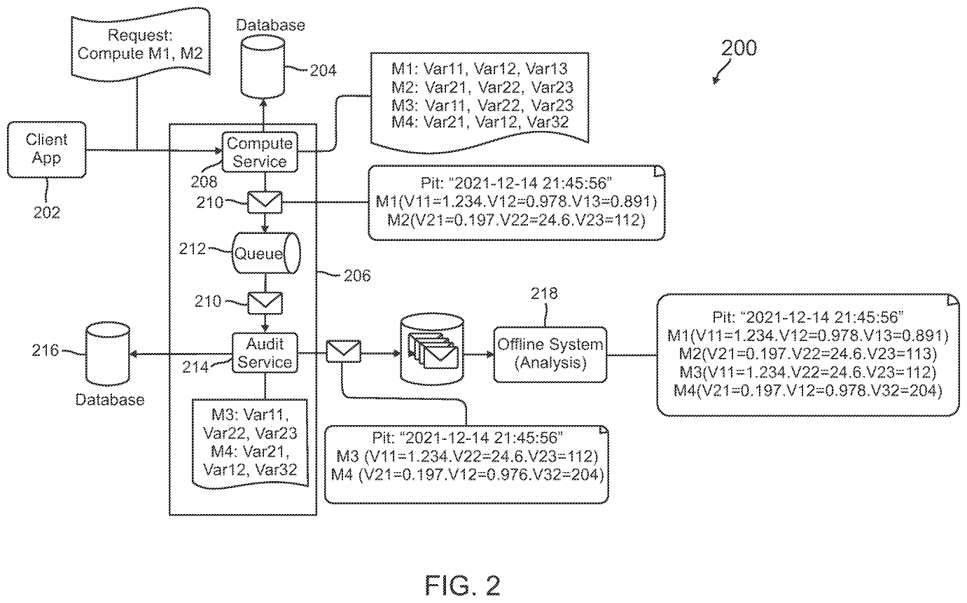

In this regard, a data load, such as request data 114, for an ML model and operations received by production computing environment 130 during normal live production computing may be processed in real-time or responsive to the request by adjudication ML system 136, where values may then be associated with those variable for ML variables and values 138. For example, a time to load may be measured in milliseconds (ms) or the like that may be required to load data for processing and determine one or more values for one or more variables, and which may have PIT ML models that require real-time adjudication in production computing environment 130. Thus, adjudication ML system 136 may compute values for variables that are shared in directed graphs (e.g., DAGs or the like) between ML models of adjudication ML system 136 with those ML models being trained using audit ML system 142. Audit ML system 142 may have one or more of those variables, and thus corresponding values determined from the data load that is shared between ML variables and values 144 with ML variables and values 138. This may be done by publishing and/or otherwise transmitting a message or log of the values for the variables at the corresponding PIT, which allows for reuse of the values by audit ML system 142 during ML model training. The operations to identify variables and their computed values shared between one or more ML models from adjudication ML system 136 and audit ML system 142 are discussed in more detail with regard to FIGS. 2-4 below.

Additionally, service provider server 120 includes database 122. Database 122 may store various identifiers associated with client device 110. Database 122 may also store account data, including payment instruments and authentication credentials, as well as transaction processing histories and data for processed transactions. Database 122 may store financial information and tokenization data. Database 122 may further store data necessary for production computing environment 130 and non-production computing environment, including application data, data loads and requests, calculated or determine values for ML models, ML model directed graphs and dependencies of variables, and the like for one or more of adjudication ML system 136 and/or audit ML system 142.

In various embodiments, service provider server 120 includes at least one network interface component 128 adapted to communicate client device 110 over network 150. In various embodiments, network interface component 128 may comprise a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency (RF), and infrared (IR) communication devices.

Network 150 may be implemented as a single network or a combination of multiple networks. For example, in various embodiments, network 150 may include the Internet or one or more intranets, landline networks, wireless networks, and/or other appropriate types of networks. Thus, network 150 may correspond to small scale communication networks, such as a private or local area network, or a larger scale network, such as a wide area network or the Internet, accessible by the various components of system 100.

FIG. 2 is an exemplary system environment 200 where a compute service and compute items from a real-time prediction pool are published and utilized in an audit and training pool for machine learning models, according to an embodiment. System environment 200 of FIG. 2 includes operations and services that may be utilized between production computing environment 130 and non-production computing environment 140 discussed in reference to system 100 of FIG. 1, which may be provided by service provider server 120. In this regard, a client application 202 may provide data utilized to compute values for variables that may be used in both computing environment for adjudication and training associated with ML models.

System environment 200 shows how production computing environment 130 may be used to provide optimized and efficient training in a non-production computing environment of ML models using precomputed values and other data from live and/or real-time adjudication of data loads in the production computing environment. Client application 202 may initially request data processing, such as by requesting a compute using first and second ML models (e.g., M1 and M2). A database 204 may be used in conjunction with a ML model system 206 to provide data for a compute service 208 in order to process the requested data load and compute, as well as determine directed graphs for one or more ML models that are deployed and/or being trained by ML model system 206. For example, for ML models M1 and M2, compute service 208 may use the graphs or other designations of dependencies of the ML models on variables used for intelligent decision-making and other predictive outputs or classifications, which may be stored in database 204. Compute service 208 may further identify additional ML models M3 and M4 that are being trained and/or tested, which share one or more of the variables of ML models M1 and M2 being used for adjudication or other processing and outputs associated with the requested compute and data load for compute service 208.

Thus, system environment 200 of FIG. 2 displays a platform that allows PIT decision-making by ML models, as well as offline processing of data utilized from that PIT decision-making. Production computing environment 130 may be utilized to provide real-time and/or user responsive ML outputs based on input data loads, requests, and the like. The ML models in production computing environment 130 may utilize variables, as identified and determined from one or more graphs (e.g., directed graphs, DAGs, and the like), in order to provide intelligent decision-making, predictions, classifications, and the like as outputs. In order to train these ML models, compute service 208 may interact with audit service 214 in order to provide data, via the computational platform, for optimizing ML model training.

In this regard, M1 may include variables Var11, Var12, and Var13, while M2 may include variables Var21, Var22, and Var23. ML models M3 and M4 for training and testing may include M3 having Var11, Var22, and Var23 and M4 having Var21, Var12, and Var32. Thus, M3 shares three variables between both M1 and M2 and M4 shares two variables of Var21 and Var12 with both M1 and M2. Compute service 208 may then determine values for the variables in M1 and M2 during adjudication or other processing requested by client application 202 with compute service 208 using the data for the requested compute using M1 and M2. To provide increased efficiency in generating training data of M3 and M4, compute service 208 may then publish, share, and/or transmit the computed values for the shared variables after computation by those variables when executing and processing data using M1 and M2 from the request by client application 202.

After determination of the adjudication and therefore the values of the variables for M1 and M2, compute service 208 may publish a message 210 or other data using a publishing and/or electronic communication system to a queue 212 that transmits message 210 to an audit service 214. Message 210 is shown having a PIT, or timestamp, that identifies when the computation of the values for the variables of the ML model occurred. Further, message 210 shows a link or association of each variable with a corresponding value, which may be a numerical value, vector having n-dimensions, or the like that allows for reuse and re-computation of the value for the variables shared with M3 and M4. Audit service 214 may receive and/or access message 210 from queue, such as at a time of generating training data and/or training/testing M3 and M4. In order to identify the shared variables of M3 and M4 with those precomputed by compute service 208 and listed in message 210 for M1 and M2, audit service 214 may then utilize a database 216 to access directed graphs (e.g., DAGs) or other data for the dependencies of ML models M3 and M4 on variables used by ML model system 206.

If variables are shared, audit service 214 may then transmit message 210 or other data for the values of the shared variables to an offline system 218 for analysis and use as training data. The values may therefore be recycled from their original computation and recalculation of those values are not required for the training data having that data load. The PIT allows for identification and correlation of the data in message 210 with the data that was processed by compute service 208 from the request by client application 202, which allows for generation of the training data having precomputed values for shared variables and other data from the request that needs to be processed and have values determined from unshared version. This enables the data to be cached with a PIT for recomputing of the values with ML models by audit service 214 in offline system 218. Thus, the training data may be more efficiently generated and shared between compute service 208 and audit service 214 so that re-computation of predetermined values for shared variables is not required and computing resources are conserved.

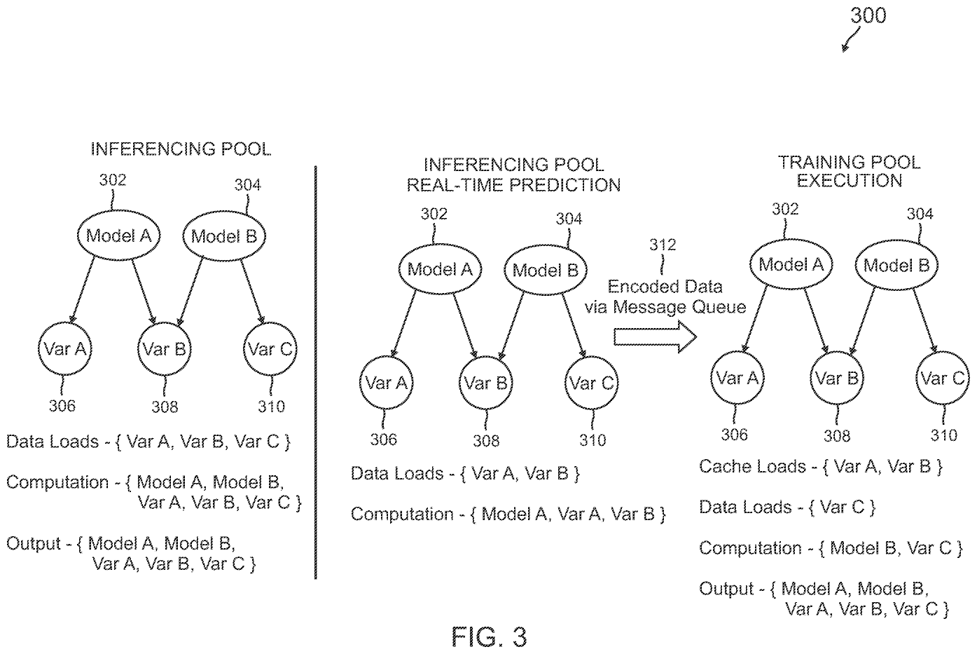

FIG. 3 is an exemplary diagram 300 of a usage of compute items for variables from a real-time prediction pool utilizing in a training pool for machine learning models, according to an embodiment. Diagram 300 includes different machine pools that may execute ML models in production (e.g., adjudication, which may be a real-time or near real-time system) and non-production (e.g., audit, which may be an ML model training system) computing environment, such as when using service provider server 120 in system 100 of FIG. 1. In this regard, encoding and publishing of values for variables is shown in FIG. 3 using the components and operations in system environment 200 of FIG. 2.

In diagram 300, a conventional inferencing pool is shown on the left, where a model A 302 and a model B 304 may have dependencies on a variable A 306, a variable B 308, and a variable C 310. Model A 302 has a dependency alone on variable A 306 and model B 304 has a dependency alone on variable C 310, while model A 302 and model B 304 share a dependency on variable B 308. Thus, when computing values for variables and having model outputs (e.g., based on the calculated values for the variables), in the interference pool on the left of diagram 300, data loads for variable A 306, variable B 308, and variable C 310 are each loaded, a computation of model A 302 and model B 304 with variable A 306, variable B 308, and variable C 310 is performed, and outputs for model A 302 and model B 304 with variable A 306, variable B 308, and variable C 310 are generated. This may be inefficient as variable B 308 is shared between models and may not need to be recomputed if model A 302 or model B 304 is an ML model in an audit environment that may utilize precomputed values for the variables for training data. However, by determining shared variables used by one or more models in order to efficiently generate training data based on precomputed values for the shared variables, cache loads may be used for value of the variables after storing and publishing or transmitting via a queue as a message for an audit computing environment and system that trains ML models.

Each variable may have a definition or other metadata used for tracking usage of the variable between different ML models, including those deployed in a production computing environment and those in an audit computing environment. For example, a variable definition may correspond to a description or identifier (including correlation IDs for data and/or data objects) that is associated with each variable. The definition may be parsed in order to determine if variables are correlated and linked between different ML models for reuse of computed values for those variables from data, requests, and/or operations by ML models in a live production computing environment. A variable definition may include “account first name,” and may further include a resource used to load the account first name in certain embodiments. Thus, variables that include the same or similar definition or identifier, e.g., account first name, may be used in order to correlate identifiers for variables in different ML models. However, in other embodiments, different metadata may be used to determine variables in each ML model, such as by identifying and correlating a corresponding data object, data loaded by each variable, or another variable functionality for each variable.

Thus, in the implementations of an inference pool (e.g., subset of machines, computes, or the like that process data and determine outputs of ML models) for real-time prediction and a training pool execution shown in the right of diagram 300, encoded message data 312 may be used to generate training data more efficiently for ML models by reusing and providing values precomputed from the real-time prediction during the training pool execution. In an example, during the real-time prediction in the inferencing pool to the right in diagram 300, model A 302 may be executed having data loads for variable A 306 and variable B 308. Computation may then include an output based on computing model A 302 with variable A 306 and variable B 308. Encoded message data 312 may then be transmitted, stored, and/or published, such as via a messaging queue. When training, testing, or otherwise utilizing model A 302 and model B 304 in an offline and/or audit computing environment and system having a pool of machines, cached loads for variable A 306 and variable B 308 are retrieved and used, and instead the data load is for variable C 310 where a corresponding value was not previously determined. The computation therefore may require computation of model B 304 having variable C 310, while the values for variable A 306 and variable B 308 may be reused. The output may then be for model A 302 and model B 304 with variable A 306, variable B 308, and variable C 310.

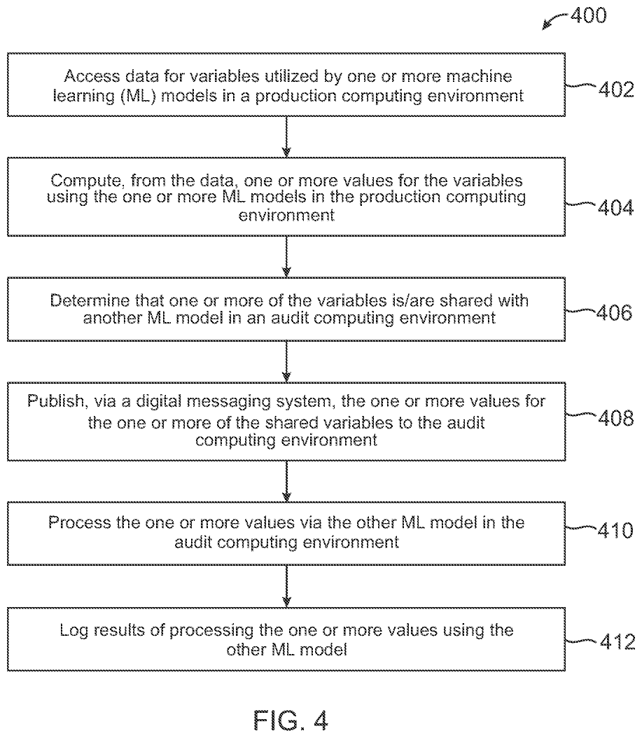

FIG. 4 is a flowchart 400 of an exemplary process for optimizing training data generation from real-time prediction systems for intelligent model training, according to an embodiment. Note that one or more steps, processes, and methods described herein of flowchart 400 may be omitted, performed in a different sequence, or combined as desired or appropriate.

At step 402 of flowchart 400, data for variables utilized by one or more ML models in a production computing environment is accessed. The data may come from a request by a computing device, server, or other endpoint, which may request usage of a service, content access, and/or data processing. For example, a user may access a service provider's platform, website, application, or the like, such as a transaction processor, and may request usage or access of and/or data processing using one or more computing services. These computing services may utilize ML models for intelligent outputs in the production computing environment, such as real-time in response to requests from the user's computing device. These may include requests for electronic transaction processing, which may include fraud detection models, authentication, account creation or usage, and the like. Other service providers may provide other types of computing services.

At step 404, from the data, one or more values for the variables is/are computed using the one or more ML models in the production computing environment. The ML models may utilize variables for nodes and/or layers, which a mathematical representation and/or operation at each variable provides a value output. The value may correspond to a number, vector or portion of a vector, or the like. Each ML model may have a graph or other representation of the dependencies of each ML model on corresponding variables. Variables may be identified by their identifier, metadata, output, or the like. Thus, as the data is processed by each variable and a corresponding value is determined from the data load, the values may be determined, recorded, and/or utilized by the corresponding ML model to provide an intelligent output.

At step 406, it is determined that one or more of the variables is/are shared with another ML model in an audit computing environment. For example, using the information that identifies each variable, correlations on the use of variables used to generate and train ML models that are shared between different ML models may be identified. Thus, the variables that may also be used by one or more ML models in the audit computing environment that are shared with ML models from the production computing environment may be identified. The audit computing environment may correspond to a non-production and/or audit pool of machines, which may also be offline in some embodiments, that is used to train and test ML models for deployment in the production computing environment for adjudication of requests by users' computing devices.

At step 408, the one or more values for the one or more of the shared variables is/are published, via a digital messaging system, to the audit computing environment. When the variables are shared by an ML model that is adjudicating a specific data load or user request and an ML model that is being trained and/or tested using the data load or user request, the value determined for the variable by the ML model in the production computing environment may be the same value later further determined by the ML model being trained and/or tested in the audit computing environment. Since the training and/or testing may occur at a later time and/or does not require live or real-time adjudication and/or decision-making, reuse of the value of the variable in the audit computing environment may conserve computing resources and reduce computation power usage by the corresponding machines. As such, a message may be generated for those values, which may be published using a queue and via a digital messaging system, or otherwise transmitted, to one or more audit computes for the audit computing environment for access and use.

At step 410, the one or more values is/are processed via the other ML model in the audit computing environment. The audit computing environment may then determine, based on information for variables and/or directed graphs, DAGs, or other information for variable dependencies for different ML models, which shared variables have precomputed values from use in the production computing environment. These values may be taken from one or more messages and/or stored data, which may then be used as training data during training and testing of ML models in the audit computing environment. The training data may therefore be made more efficient by not requiring recalculation of those values for the corresponding variables when computation in the production computing environment has occurred. At step 412, results of processing the one or more values using the other ML model are logged. The results may be logged in order for review of the ML model during training and testing and determination of whether further training data is required. A data scientist, developer, administrator, or other end user may therefore access the results to determine the efficacy of the corresponding ML model.

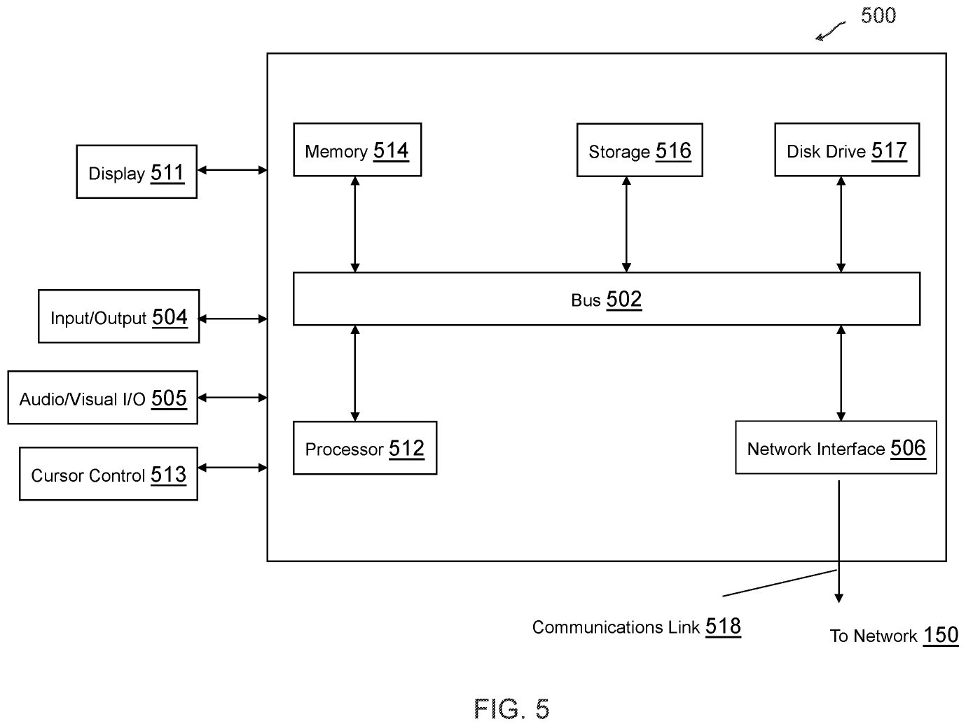

FIG. 5 is a block diagram of a computer system 500 suitable for implementing one or more components in FIG. 1, according to an embodiment. In various embodiments, the communication device may comprise a personal computing device e.g., smart phone, a computing tablet, a personal computer, laptop, a wearable computing device such as glasses or a watch, Bluetooth device, key FOB, badge, etc.) capable of communicating with the network. The service provider may utilize a network computing device (e.g., a network server) capable of communicating with the network. It should be appreciated that each of the devices utilized by users and service providers may be implemented as computer system 500 in a manner as follows.

Computer system 500 includes a bus 502 or other communication mechanism for communicating information data, signals, and information between various components of computer system 500. Components include an input/output (I/O) component 504 that processes a user action, such as selecting keys from a keypad/keyboard, selecting one or more buttons, image, or links, and/or moving one or more images, etc., and sends a corresponding signal to bus 502. I/O component 504 may also include an output component, such as a display 511 and a cursor control 513 (such as a keyboard, keypad, mouse, etc.). An optional audio input/output component 505 may also be included to allow a user to use voice for inputting information by converting audio signals. Audio I/O component 505 may allow the user to hear audio. A transceiver or network interface 506 transmits and receives signals between computer system 500 and other devices, such as another communication device, service device, or a service provider server via network 150. In one embodiment, the transmission is wireless, although other transmission mediums and methods may also be suitable. One or more processors 512, which can be a micro-controller, digital signal processor (DSP), or other processing component, processes these various signals, such as for display on computer system 500 or transmission to other devices via a communication link 518. Processor(s) 512 may also control transmission of information, such as cookies or IP addresses, to other devices.

Components of computer system 500 also include a system memory component 514 (e.g., RAM), a static storage component 516 (e.g., ROM), and/or a disk drive 517. Computer system 500 performs specific operations by processor(s) 512 and other components by executing one or more sequences of instructions contained in system memory component 514. Logic may be encoded in a computer readable medium, which may refer to any medium that participates in providing instructions to processor(s) 512 for execution. Such a medium may take many forms, including but not limited to, non-volatile media, volatile media, and transmission media. In various embodiments, non-volatile media includes optical or magnetic disks, volatile media includes dynamic memory, such as system memory component 514, and transmission media includes coaxial cables, copper wire, and fiber optics, including wires that comprise bus 502. In one embodiment, the logic is encoded in non-transitory computer readable medium. In one example, transmission media may take the form of acoustic or light waves, such as those generated during radio wave, optical, and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EEPROM, FLASH-EEPROM, any other memory chip or cartridge, or any other medium from which a computer is adapted to read.

In various embodiments of the present disclosure, execution of instruction sequences to practice the present disclosure may be performed by computer system 500. In various other embodiments of the present disclosure, a plurality of computer systems 500 coupled by communication link 518 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A system comprising:
a non-transitory memory; and
one or more hardware processors coupled to the non-transitory memory and configured to read instructions from the non-transitory memory to cause the system to perform operations comprising:
computing, for a first machine learning (ML) model in an adjudication ML engine for a live production computing environment, a plurality of values for a plurality of variables used by the first ML model for an intelligent decision-making with the adjudication ML engine;
determining that at least one first variable of the plurality of variables is shared with a second ML model in an audit ML engine separate from the live production computing environment;
publishing, using a messaging system, at least one first value corresponding to the at least one first variable for the audit ML engine;
processing, based on the publishing, the at least one first value using the second ML model in the audit ML engine for a first training of the second ML model; and
logging first training results from the first training of the second ML model based at least on the processing.

2. The system of claim 1, wherein the first value is used with training data for the first training of the second ML model by the audit ML engine prior to a deployment of the second ML model to the live production computing environment, and wherein the processing the at least one first value using the second ML model in the audit ML engine for a first training comprises:
calculating at least one second value for at least one second variable of the second ML model, wherein the at least one second variable is not shared between the first ML model and the second ML model; and
processing the at least one first value with the at least one second value using the second ML model in the audit ML engine for the first training of the second ML model.

3. The system of claim 1, wherein prior to the processing, the operations further comprise:
determining metadata for the first ML model, the second ML model, and the at least one first variable; and
determining that the at least one first variable is shared between the first ML model and the second ML model based on the metadata.

4. The system of claim 3, wherein the determining that the at least one first variable is shared between the first ML model and the second ML model is further based on a directed graph for at least one of the first ML model and the second ML model.

5. The system of claim 1, wherein prior to the processing, the operations further comprise:
determining a second value of a second variable used by a third ML model, wherein the second variable is shared between the second ML model and the third ML model,
wherein the processing further uses the second value.

6. The system of claim 5, wherein the third ML model is used in the adjudication ML engine for the live production computing environment for the intelligent decision-making by the adjudication ML engine.

7. The system of claim 1, wherein the at least one first value is further used for a validation of the second ML model by the audit ML engine.

8. The system of claim 1, wherein the adjudication ML engine is associated with at least one of a fraud detection system, an authentication system for digital accounts, or an electronic transaction processing system.

9. The system of claim 1, wherein the audit ML engine is utilized in a test computing environment that does not provide the intelligent decision-making for adjudications in the live production computing environment.

10. A method comprising:
receiving data for a first machine learning (ML) model executable by an adjudication ML system in a production computing environment;
determining, from the data, a first value for a first variable of the first ML model based on a decision by the adjudication system in the production computing environment;
publishing a message having the first value for the first variable to an audit ML system having a second ML model being trained and tested by the audit ML system, wherein the second ML model utilizes the first variable;
utilizing, from the message, the first value for the first variable with the second ML model in the audit ML system; and
logging results data for the second ML model based on the utilizing.

11. The method of claim 10, wherein the data for the first ML model is utilized with the second ML model in the audit ML system for at least one of a training of the second ML model or a validation of the second ML model.

12. The method of claim 10, further comprising:
determining dependencies for variables used by the first ML model and the second ML model; and
determining that the first variable is shared between the first ML model and the second ML model based on the dependencies,
wherein the first value for the first variable is utilized with the second ML model based on determining that the first variable is shared between the first ML model and the second ML model

13. The method of claim 12, wherein the dependencies of the first ML model and the second ML model are determined based on at least one of metadata for the variables or directed graphs for at least one of the first ML model and the second ML model.

14. The method of claim 10, further comprising:
determining a second value for a second variable used by a third ML model with the data in by the adjudication ML system,
wherein the utilizing further includes utilizing the second value for the second variable with the second ML model in the audit ML system.

15. The method of claim 10, wherein the utilizing comprises reducing a number of data calls required for training or validating of the second ML model in the audit ML system using the data.

16. The method of claim 10, wherein the publishing caches the message with the first value in a data cache associated with the audit ML system.

17. The method of claim 10, wherein the decision by the adjudication system is associated with one of a fraud detection, a login, or an electronic transaction processing.

18. A non-transitory machine-readable medium having stored thereon machine-readable instructions executable to cause a machine to perform operations comprising:
receiving a request for decision-making by a first machine learning (ML) model for an adjudication ML system in a production computing environment, wherein the request comprises data for the decision-making by the first ML model, and wherein the first ML model comprises a first variable shared with a second ML model for an audit ML system in a non-production computing environment;
determining a first value of the first variable based on the data from the request and the first ML model;
determining, from metadata for the first variable, that the first variable is shared between the first ML model and the second ML model;
publishing a message having the first value for the first variable to the audit ML system; and
processing the first value for the first variable during a training of the second ML model independent of determining the first value for the first variable by the audit ML system during a test of the second ML model.

19. The non-transitory machine-readable medium of claim 18, wherein the operations further comprise:
determining a second value of a second variable based on the data from the request and the first ML model,
wherein the message is further published having the second value of the second variable for the audit ML system.

20. The non-transitory machine-readable medium of claim 18, wherein the audit ML system comprises a plurality of ML models including the second ML model for training, testing, and deploying the plurality of ML models from the non-production computing environment to the production computing environment, and wherein the operations further comprise:
logging results of the training of the second ML model by the audit ML system.
